(19) United States
(12) Patent Application Publication
(10) Pub. No.: US 2015/0138067 A1
(43) Pub. Date: May 21, 2015

(54) METHOD OF TRANSMITTING AND RECEIVING DATA, AND DISPLAY APPARATUS AND POINTING APPARATUS USING THE SAME

(71) Applicant: Electronics and Telecommunications Research Institute, Daejeon (KR)

(72) Inventors: Do Won NAM, Daejeon (KR); Bum Ho KIM, Daejeon (KR); Jeong Woo LEE, Daejeon (KR); Ki Song YOON, Daejeon (KR); Yeon Jeong JEONG, Daejeon (KR); Hyo Taeg JUNG, Daejeon (KR); Jung Soo LEE, Jeonju (KR); Sung Won MOON, Daejeon (KR)

(21) Appl. No.: 14/320,345

(22) Filed: Jun. 30, 2014

(30) Foreign Application Priority Data
Nov. 19, 2013 (KR) 10-2013-0140790

(51) Int. Cl. G06F 3/033; G06F 3/0354

(52) U.S. Cl. CPC G06F 3/033; G06F 3/03545; G09G 2370/02; G09G 2370/16
USPC 345/156

(57) ABSTRACT

Provided is a data transmitting and receiving method in which a display apparatus connectable to a wireless network transmits and receives data to and from a user terminal by using a pointing apparatus. The data transmitting and receiving method includes (a) acquiring position information of a region, pointed by the pointing apparatus, in the display apparatus and (b) transmitting data, corresponding to an object displayed in the region on a screen of the display apparatus, to the user terminal by using the pointing apparatus.

### CROSS-REFERENCE TO RELATED APPLICATIONS

This application claims priority under 35 U.S.C. §119 to Korean Patent Application No. 10-2013-0140790, filed on Nov. 19, 2013, the disclosure of which is incorporated herein by reference in its entirety.

### TECHNICAL FIELD

The present invention relates to a method of transmitting and receiving data between a display apparatus and a user terminal, and more particularly, to a method that interfaces data transmitted and received between a display apparatus and a user terminal by using a pointing apparatus.

### BACKGROUND

There are many cases in which information is transferred between a personal terminal apparatus and an apparatus, which is not possessed by an individual, such as a digital signage for advertisements or a display apparatus for public places. This is because the digital signage for advertisements and the display apparatus for public places are used for the purpose of transferring various pieces of information to individuals. Such information transfer is generally performed in the following methods.

1. When an email address is input to a display apparatus, information is transmitted to the email address.

2. A QR code is shown, and by photographing the QR code with a personal user terminal, information is accessed and downloaded on the Web.

In the above-described information transfer methods of the related art, a user checks an email one by one, downloads an attached file, stores the downloaded file in a corresponding apparatus, and checks information, which is necessary to execute the downloaded file, in application software, causing inconvenience to the user.

Moreover, there is inconvenience in which a user photographs the QR code displayed on a screen of a display apparatus by using a personal user terminal which is carried by the user, and downloads information from a website which is accessed with the QR code.

### SUMMARY

Accordingly, the present invention provides a user interface for efficiently controlling data communication between a display apparatus and a user terminal.

The object of the present invention is not limited to the aforesaid, but other objects not described herein will be clearly understood by those skilled in the art from descriptions below.

In one general aspect, a data transmitting and receiving method, in which a display apparatus connectable to a wireless network transmits and receives data to and from a user terminal by using a pointing apparatus, includes: (a) acquiring position information of a region, pointed by the pointing apparatus, in the display apparatus; and (b) transmitting data, corresponding to an object displayed in the region on a screen of the display apparatus, to the user terminal by using the pointing apparatus.

The data transmitting and receiving method may further include, before step (a), establishing, by the display apparatus, a network connection with the pointing apparatus.

The transmitting of data may include, when a command for a copy operation or a movement operation is input from the pointing apparatus, transmitting the data corresponding to the object to the pointing apparatus.

The data transmitted to the pointing apparatus may be stored in the pointing apparatus.

The transmitting of data may include: establishing, by the pointing apparatus, a network connection with the user terminal; and when a command for a paste operation or a movement operation is input from the pointing apparatus, transmitting the data to the user terminal.

The transmitting of data may include: when a command for a copy operation or a movement operation is input from the pointing apparatus, transmitting the data corresponding to the object to a cloud server network-connected to the display apparatus; and downloading, by the user terminal, the data stored in the cloud server.

In another general aspect, a data transmitting and receiving method, in which a display apparatus connectable to a wireless network transmits and receives data to and from a user terminal by using a pointing apparatus, includes: establishing, by the display apparatus, a network connection with the pointing apparatus; acquiring position information of a first region, pointed by the pointing apparatus, in the display apparatus; when a first command for a copy operation or a movement operation is input from the pointing apparatus, transmitting data, corresponding to a first object displayed in the first region, to the pointing apparatus; acquiring position information of a second region, pointed by the pointing apparatus, in the display apparatus; and when a second command for the copy operation or the movement operation is input from the pointing apparatus, transmitting data, corresponding to a second object displayed in the second region, to the pointing apparatus.

The data transmitting and receiving method may further include: storing, by the pointing apparatus, the data respectively corresponding to the first and second objects; establishing, by the pointing apparatus, a network connection with the user terminal; when a command for a paste operation or a movement operation is input from the pointing apparatus, providing a data list corresponding to the first and second objects; and transmitting data, selected from the data list, to the user terminal.

In another general aspect, a display apparatus for transmitting and receiving data to and from a user terminal by using a pointing apparatus connectable to a wireless network includes: a display unit configured to display a plurality of objects on a screen; a network interface configured to establish a network connection for communication with the pointing apparatus, and transmit and receive data to and from the pointing apparatus over the connected network; and a control unit configured to perform control to acquire position information of a region, pointed by the pointing apparatus, in the display unit, and transmit data, corresponding to an object displayed in the region, to the pointing apparatus.

When a command for a copy operation or a movement operation is input from the pointing apparatus through the network interface, the control unit may perform control to transmit the data corresponding to the object to the pointing apparatus.

In another general aspect, a pointing apparatus for transmitting and receiving data of a display apparatus, which is connectable to a wireless network, to and from a user terminal, includes: a first network interface configured to establish a network connection for communication with the display apparatus, and transmit and receive data to and from the display apparatus over the connected network; a storage unit configured to store a program, which is used to drive the pointing apparatus, and data transmitted and received to and from the display apparatus; an input interface configured to input a user command for selecting, copying, pasting, or moving arbitrary data among a plurality of pieces of data stored in the storage unit; a second network interface configured to establish a network connection for communication with the user terminal, and transmit and received data to and from the user terminal over the connected network; and a control unit configured to, when a command for a copy operation or a movement operation is input through the input interface, perform control to receive data from the display apparatus, and when a command for a paste operation or a movement operation is input, perform control to transmit arbitrary data among a plurality of pieces of data, stored in the storage unit, to the user terminal.

When a command for selecting arbitrary data is input through the input interface, the control unit may perform control to provide a data list stored in the storage unit.

Other features and aspects will be apparent from the following detailed description, the drawings, and the claims.

### BRIEF DESCRIPTION OF THE DRAWINGS

FIG. 1 is a diagram illustrating a configuration of a data transmitting and receiving system according to an embodiment of the present invention.

FIG. 2 is a diagram illustrating a configuration of a display apparatus according to an embodiment of the present invention.

FIG. 3 is a diagram illustrating a configuration of a pointing apparatus according to an embodiment of the present invention.

FIG. 4 is a diagram illustrating a data transmitting and receiving method according to an embodiment of the present invention.

FIG. 5 is a view illustrating a configuration of a computer device in which a data transmitting and receiving method according to an embodiment of the present invention is executed.

### DETAILED DESCRIPTION OF EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. In the following description, the technical terms are used only for explaining a specific exemplary embodiment while not limiting the present invention. The terms of a singular form may include plural forms unless specifically mentioned.

Hereinafter, exemplary embodiments of the present invention will be described in detail with reference to the accompanying drawings. In adding reference numerals for elements in each figure, it should be noted that like reference numerals already used to denote like elements in other figures are used for elements wherever possible. Moreover, detailed descriptions related to well-known functions or configurations will be ruled out in order not to unnecessarily obscure subject matters of the present invention.

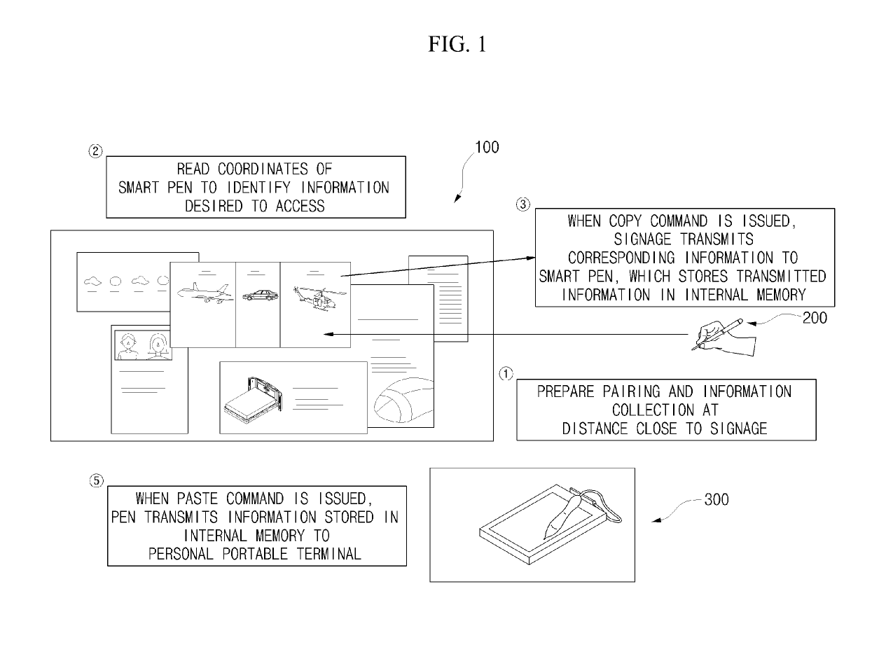

FIG. 1 is a diagram illustrating a configuration of a data transmitting and receiving system according to an embodiment of the present invention. The data transmitting and receiving system may include a display apparatus 100, a pointing apparatus 200, and a user terminal 300.

Although not shown, the data transmitting and receiving system may further include a cloud server that is connected to the display apparatus 100 over a wireless network.

Referring to FIG. 1, the display apparatus 100 may be an image display apparatus such as a television (TV), a monitor, a notebook computer, or a tablet personal computer (PC) which is connectable to the pointing apparatus 200 over the wireless network. Alternatively, the display apparatus 100 may be an apparatus, which is not possessed by an individual, such as a digital signage for advertisements or a display apparatus for public places.

For example, the display apparatus 100 may be a network TV, an Internet protocol (IP) TV, a hybrid broadcast broadband TV (HBBTV), or a smart TV, which performs various user-friendly functions because various applications are freely added or deleted in a general-use operating system (OS) kernel.

The user terminal 30 is an apparatus that is connected to the pointing apparatus 200 over the wireless network to transmit and receive data. In comparison with the display apparatus 100, the user terminal 30 has a small screen, and thus, in terms of a size and weight, the user terminal 30 may be an apparatus that is portable, and is freely movable.

For example, the user terminal 300 may be one of various apparatuses, which output an image or a voice, such as a portable phone, a smartphone, a tablet PC, a digital broadcasting terminal, a personal digital assistant (PDA), a portable multimedia player (PMP), an Internet telephone such as SoIP, a navigation apparatus, and an MP3 player.

The display apparatus 100 and the pointing apparatus 200 may be connected by one of various wireless communication schemes such as wireless LAN (WiFi), WiFi direct, WiFi display, Bluetooth, ZigBee, binary code division multiple access (CDMA), wireless broadband (Wibro), world interoperability for microwave access (Wimax), high speed downlink packet access (HSDPA), universal plug and play (UPnP)/digital living network alliance (DLBNA), and ultra wide band (UWB)/wireless universal serial bus (USB), and may mutually transmit and receive data.

Moreover, the pointing apparatus 200 and the user terminal 300 may be connected by one of the various wireless communication schemes, and may mutually transmit and receive data.

Data, which is shared by the display apparatus 100, the pointing apparatus 200, and the user terminal 300, may be various kinds of data such as a real-time broadcast, a movie, a music, a photograph, a document file, contents on demand (COD), a game, a news, a video call, an application, etc.

According to an embodiment of the present invention, the pointing apparatus 200 including a data transmission means and a memory is used as a medium for data exchange between the display apparatus 100 and the user terminal 300. An information transfer scenario using the pointing apparatus 200 is as follows.

For example, when the pointing apparatus 200 is powered on, the pointing apparatus 200 searches the display apparatus 100 to perform a paring operation, and is connected to the network.

The display apparatus 100 displays transfer-desired information on a screen. In this state, when the pointing apparatus 200 is brought into contact with a partial region of the screen, the display apparatus 100 recognizes a position pointed by the pointing apparatus 200 to identify the information displayed at the recognized position.

When a user pushes a copy button of the pointing apparatus 200, the display apparatus 100 transmits the identified information to the pointing apparatus 200, and the transmitted information is stored in a memory included in the pointing apparatus 200 (in a case where a plurality of pieces of information are displayed on a screen, when a copy operation is sequentially performed for the plurality of pieces of information, the pieces of information are sequentially stored within a capacity of the memory included in the pointing apparatus 200).

Subsequently, the user executes an application which is to be processed by its own user terminal 300, and then, when the user pushes a paste button of the pointing apparatus 200, information stored in the memory of the pointing apparatus 200 is transmitted to the user terminal 300 (when a plurality of pieces of information are stored in the memory of the pointing apparatus 200, all the pieces of information may be transmitted to the user terminal 300 by repeatedly performing a paste operation).

According to the above-described embodiment, information of a digital signage or a public display apparatus 100 may be collected by a medium which is the pointing apparatus 200 such as a smart pen, and the collected information (data) may be simply transmitted to a plurality of user terminals 300 respectively possessed by individuals.

According to the embodiment of the present invention, apparatuses may exchange information through only the copy operation and the paste operation without using an inconvenient means unlike an email, and may immediately use the information. Also, a plurality of pieces of information are quickly collected by using an information collection/storage apparatus (which is a smart pen) without needing to always carry a portable device, and later, the collected information may be used when necessary.

In another embodiment, without using a method in which information transmitted from the display apparatus 100 is stored in the memory of the pointing apparatus 200, the information may be stored in a storage space of an external cloud server apparatus network-connected to the display apparatus 100.

In such a method, when the user pushes the copy button of the pointing apparatus 200, information of the display apparatus 100 is not transmitted to the pointing apparatus 200 but is transmitted to a storage space of a network designated by the pointing apparatus 200.

When the user pushes the paste button of the pointing apparatus 200, the user terminal 300 reads information stored in the storage space of the network.

In another embodiment described above, the pointing apparatus 200 informs the display apparatus 100 or the user terminal 300 of a position of the storage space of the network which is a medium for information exchange.

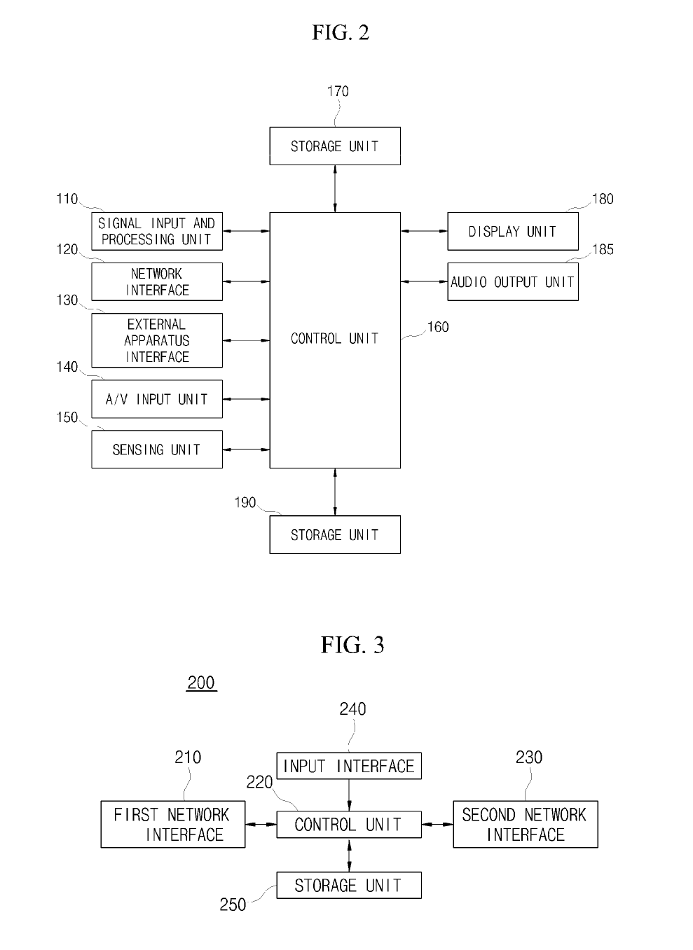

Hereinafter, an embodiment of a detailed configuration of each of the display apparatus 100 and the pointing apparatus 200 will be described in detail with reference to FIGS. 2 and 3.

Referring to FIG. 2, the display apparatus 100 may include a signal input and processing unit 110, a network interface 120, an external apparatus interface 130, an audio/video (A/V) input unit 140, a sensing unit 150, a control unit 160, a storage unit 170, a display unit 180, an audio output unit 185, and a user interface 190.

The signal input and processing unit 110 receives signal from the outside to process the signal. For example, the signal input and processing unit 110 may selectively receive a radio frequency (RF) broadcast signal, corresponding to a channel selected by a user or all pre-stored channels, among RF broadcast signals received through an antenna.

The network interface 120 may provide an interface for connecting the display apparatus 100 to a wired/wireless network, and transmit/receive data to/from an external apparatus by using various wireless communication schemes which are as described above with reference to FIG. 1.

For example, the network interface 120 may establish a wireless network connection with the pointing apparatus 200 according to a communication protocol such as WiFi or Bluetooth, and transmit/receive content data and information (which is used for data communication) to/from the pointing apparatus 200 over the connected network.

The control unit 160 controls an overall operation of the display apparatus 100, and controls operations of the signal input and processing unit 110, the network interface 120, and the display unit 180.

In particular, the control unit 160 processes an image signal in order for a plurality of objects to be displayed in the display apparatus 180, and acquires position information of a region, pointed by the pointing apparatus 200, of the display unit 180.

Moreover, the control unit 160 recognizes data corresponding to an object displayed in the region pointed by the pointing apparatus 200, and allows the data to be transmitted to the pointing apparatus 200.

To provide a detailed description, when a command for the copy operation or a movement operation is input from the pointing apparatus 200 through the network interface 120, the control unit 160 executes a program used to process the command to acquire position information of a region pointed by the pointing apparatus 200, and searches the storage unit 170 to acquire data corresponding to an object displayed in the region. The acquired data is transmitted to the pointing apparatus 300 through the network interface 120.

In another embodiment, when a command for the copy operation or the movement operation is input from the pointing apparatus 200 through the network interface 120, the control unit 160 may execute a program used to process the command to acquire data, and as described above, the control unit 160 may transmit the acquired data to the external cloud server apparatus (not shown) network-connected to the display apparatus 100 through the network interface 120.

In another embodiment, the control unit 160 acquires position information of a first region, pointed by the pointing apparatus 200, in a screen of the display unit 180, and when a first command for the copy operation or the movement operation is input from the pointing apparatus 200, the control unit 160 may execute a program used to process the first command to transmit data, corresponding to a first object displayed in the first region, to the pointing apparatus 200. Subsequently, the pointing apparatus 200 points a second region which is different from the first region, and then, when a second command for the copy operation or the movement operation is input, the control unit 160 may execute a program used to process the second command to transmit data, corresponding to a second object displayed in the second region, to the pointing apparatus 200.

The display unit 180 may provide a screen exposed to a front surface of the display apparatus 100, for displaying an image.

The display unit 180 converts an image signal, a data signal, and an on-screen display (OSD) signal (which are obtained through processing by the control unit 160) or an image signal and a data signal (which are received by the external apparatus interface 130) into red (R), green (G), and blue (B) signals to generate a driving signal, thereby allowing an object to be displayed on the screen.

Referring to FIG. 3, the pointing apparatus 200 may include a first network interface 210, a control unit 220, a second network interface 230, an input interface 240, and a storage unit 250.

The first network interface 210 establishes a network connection for communication with the display apparatus 100, and transmits/receives data to/from the display apparatus 100 over the connected network.

The second network interface 230 establishes a network connection for communication with the user terminal 300, and transmits/receives data to/from the user terminal 300 over the connected network.

The storage unit 250 stores a program used to drive the pointing apparatus 200 and data shared by the display apparatus 100 and the user terminal 300.

The input interface 240 provides a user interface for inputting a user command for selecting, copying, pasting, or moving arbitrary data among a plurality of pieces of data stored in the storage unit 250.

The control unit 220 controls an overall operation of the pointing apparatus 200, and in detail, performs operations such as a network connection establishment of the first and second network interfaces 210 and 230 and processing of a command which is input through the input interface 240.

In particular, when a command for the copy operation or the movement operation is input from the input interface 240, the control unit 220 executes a program used to process the command to transmit the command to the display apparatus 100 through the first network interface 210.

As a result, when data is received from the display apparatus 100, the control unit 220 stores the data in the storage unit 250.

When a command for the paste operation or the movement operation is input from the input interface 240, the control unit 220 executes a program used to process the command to transmit arbitrary data among a plurality of pieces of data, stored in the storage unit 250, through the second network interface 230.

Moreover, when a command for selecting arbitrary data is input from the input interface 240, the control unit 220 provides a data list stored in the storage unit 250.

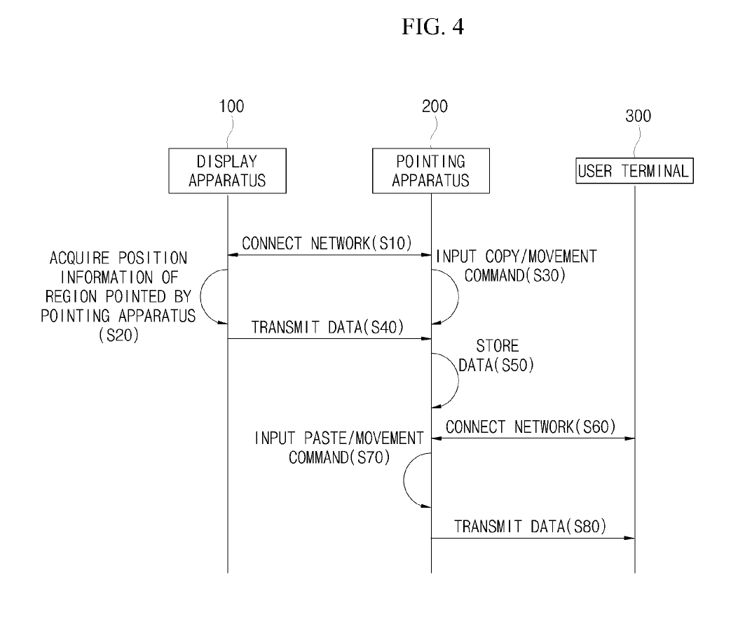

An operation of the above-described data transmitting and receiving system according to the present invention will be sequentially described with reference to FIG. 4.

FIG. 4 is a diagram illustrating a data transmitting and receiving method according to an embodiment of the present invention.

First, specific objects for providing information are displayed on a screen of the display apparatus 100. Also, the display apparatus 100 is wiredly or wirelessly network-connected to the pointing apparatus 200 at a remote distance, in operation S10.

In this state, the pointing apparatus 200 points a specific position of the screen of the display apparatus 100. At this time, the display apparatus 100 acquires position information of a region pointed by the pointing apparatus 200, in operation S20.

A user inputs a command for the copy operation or the movement operation in the pointing apparatus 200 in operation S30, and the input command is transmitted to the display apparatus 100 through a network connection. The display apparatus 100 executes a program used to process the command to transmit data, corresponding to an object of a region pointed by the pointing apparatus 200, to the pointing apparatus 200 according to the transmitted command, in operation S40. At this time, the transmitted data may be stored in a storage means included in the pointing apparatus 200, in operation S50.

Furthermore, while the user is carrying the pointing apparatus 200, the user performs an operation of transmitting data to the user terminal to which data is to be transferred. To this end, a network connection for data transmission/reception is established between the pointing apparatus 200 and the user terminal 300, in operation S60. A network connection between the pointing apparatus 200 and the user terminal 300 may be established by using a wired network or a wireless network, but the wireless network may be used.

Subsequently, the user inputs a command for the paste operation or the movement operation in the pointing apparatus 200 in operation S70, and the pointing apparatus executes a program used to process the command.

As a result, data is transmitted from the pointing apparatus 200 to the user terminal 300, in operation S80.

As described above, according to the present invention, provided can be the intuitive user interface that interfaces data transmitted and received between the display apparatus and the user terminal by using the pointing apparatus, thereby enabling a user to easily control data transmission/reception between the display apparatus and the user terminal.

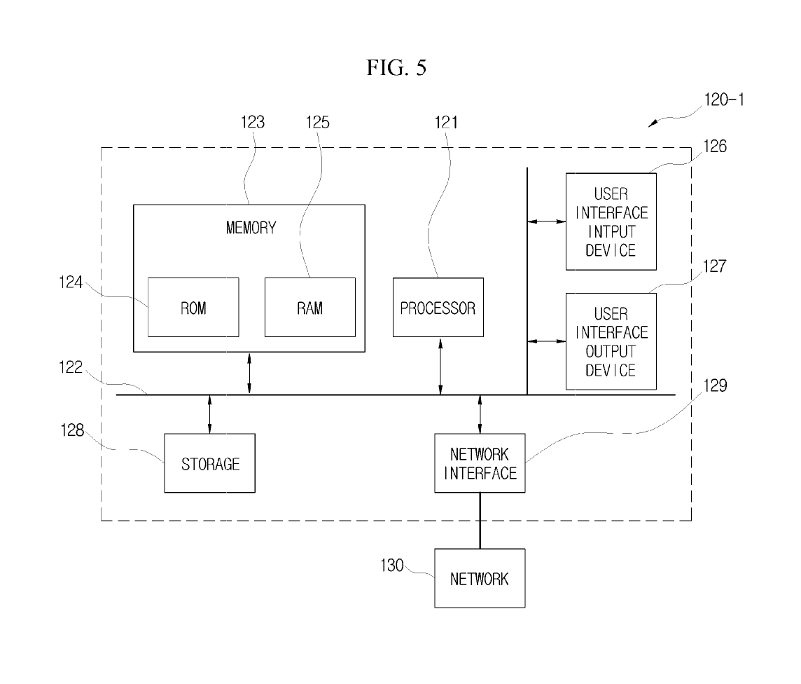

A data transmitting and receiving method according to an embodiment of the present invention may be implemented in a computer system, e.g., as a computer readable medium. As shown in FIG. 5, a computer system 120-1 may include one or more of a processor 121, a memory 123, a user input device 126, a user output device 127, and a storage 128, each of which communicates through a bus 122. The computer system 120-1 may also include a network interface 129 that is coupled to a network 130. The processor 121 may be a central processing unit (CPU) or a semiconductor device that executes processing instructions stored in the memory 123 and/or the storage 128. The memory 123 and the storage 128 may include various forms of volatile or non-volatile storage media. For example, the memory may include a read-only memory (ROM) 124 and a random access memory (RAM) 125.

Accordingly, a data transmitting and receiving method according to an embodiment of the present invention may be implemented as a computer implemented method or as a non-transitory computer readable medium with computer executable instructions stored thereon. In an embodiment, when executed by the processor, the computer readable instructions may perform a method according to at least one aspect of the invention.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A data transmitting and receiving method in which a display apparatus connectable to a wireless network transmits and receives data to and from a user terminal by using a pointing apparatus, the data transmitting and receiving method comprising:
(a) acquiring position information of a region, pointed by the pointing apparatus, in the display apparatus; and
(b) transmitting data, corresponding to an object displayed in the region on a screen of the display apparatus, to the user terminal by using the pointing apparatus.

2. The data transmitting and receiving method of claim 1, further comprising, before step (a), establishing, by the display apparatus, a network connection with the pointing apparatus.

3. The data transmitting and receiving method of claim 2, wherein the transmitting of data comprises, when a command for a copy operation or a movement operation is input from the pointing apparatus, transmitting the data corresponding to the object to the pointing apparatus.

4. The data transmitting and receiving method of claim 3, wherein the data transmitted to the pointing apparatus is stored in the pointing apparatus.

5. The data transmitting and receiving method of claim 2, wherein the transmitting of data comprises:
establishing, by the pointing apparatus, a network connection with the user terminal; and
when a command for a paste operation or a movement operation is input from the pointing apparatus, transmitting the data to the user terminal.

6. The data transmitting and receiving method of claim 1, wherein the transmitting of data comprises:
when a command for a copy operation or a movement operation is input from the pointing apparatus, transmitting the data corresponding to the object to a cloud server network-connected to the display apparatus; and
downloading, by the user terminal, the data stored in the cloud server.

7. A data transmitting and receiving method in which a display apparatus connectable to a wireless network transmits and receives data to and from a user terminal by using a pointing apparatus, the data transmitting and receiving method comprising:
establishing, by the display apparatus, a network connection with the pointing apparatus;
acquiring position information of a first region, pointed by the pointing apparatus, in the display apparatus;
when a first command for a copy operation or a movement operation is input from the pointing apparatus, transmitting data, corresponding to a first object displayed in the first region, to the pointing apparatus;
acquiring position information of a second region, pointed by the pointing apparatus, in the display apparatus; and
when a second command for the copy operation or the movement operation is input from the pointing apparatus, transmitting data, corresponding to a second object displayed in the second region, to the pointing apparatus.

8. The data transmitting and receiving method of claim 7, further comprising:
storing, by the pointing apparatus, the data respectively corresponding to the first and second objects;
establishing, by the pointing apparatus, a network connection with the user terminal;
when a command for a paste operation or a movement operation is input from the pointing apparatus, providing a data list corresponding to the first and second objects; and
transmitting data, selected from the data list, to the user terminal.

9. A display apparatus for transmitting and receiving data to and from a user terminal by using a pointing apparatus connectable to a wireless network, the display apparatus comprising:
a display unit configured to display a plurality of objects on a screen;
a network interface configured to establish a network connection for communication with the pointing apparatus, and transmit and receive data to and from the pointing apparatus over the connected network; and
a control unit configured to perform control to acquire position information of a region, pointed by the pointing apparatus, in the display unit, and transmit data, corresponding to an object displayed in the region, to the pointing apparatus.

10. The display apparatus of claim 9, wherein when a command for a copy operation or a movement operation is input from the pointing apparatus through the network interface, the control unit performs control to transmit the data corresponding to the object to the pointing apparatus.

11. A pointing apparatus for transmitting and receiving data of a display apparatus, which is connectable to a wireless network, to and from a user terminal, the pointing apparatus comprising:
a first network interface configured to establish a network connection for communication with the display apparatus, and transmit and receive data to and from the display apparatus over the connected network;
a storage unit configured to store a program, which is used to drive the pointing apparatus, and data transmitted and received to and from the display apparatus;
an input interface configured to input a user command for selecting, copying, pasting, or moving arbitrary data among a plurality of pieces of data stored in the storage unit;
a second network interface configured to establish a network connection for communication with the user terminal, and transmit and received data to and from the user terminal over the connected network; and
a control unit configured to, when a command for a copy operation or a movement operation is input through the input interface, perform control to receive data from the display apparatus, and when a command for a paste operation or a movement operation is input, perform control to transmit arbitrary data among a plurality of pieces of data, stored in the storage unit, to the user terminal.

12. The pointing apparatus of claim 11, wherein when a command for selecting arbitrary data is input through the input interface, the control unit performs control to provide a data list stored in the storage unit.
